(19) United States
(12) Patent Application Publication
(10) Pub. No.: US 2008/0102174 A1
(43) Pub. Date: May 1, 2008

(54) LIQUID DISPENSER WITH MOUNTING STRUCTURE FOR DRINKING CONTAINER

(75) Inventors: Paul Jamison, Matthews, NC (US); Daniel Lee Bizzell, Davidson, NC (US); Todd Stancombe, Charlotte, NC (US)

Correspondence Address: TILLMAN WRIGHT, PLLC, PO BOX 471581, CHARLOTTE, NC, 28247, US

(73) Assignee: YO! BRANDS, LLC, Charlotte, NC (US)

(21) Appl. No.: 11/752,285

(22) Filed: May 22, 2007

Related U.S. Application Data
(60) Provisional application No. 60/862,838, filed on Oct. 25, 2006.

(51) Int. Cl. A23G 3/50; B05B 11/00; B65B 1/04

(52) U.S. Cl. 426/104; 222/78; 141/363

(57) ABSTRACT

A liquid dispenser comprises a body defining an interior containment space for containing a liquid to be dispensed and a structure configured to mount the liquid dispenser onto a drinking container such that the liquid dispenser does not obstruct drinking from a rim of the drinking container.

### I. CROSS-REFERENCE TO RELATED PATENT APPLICATION

This application is a U.S. nonprovisional patent application of, and claims priority under 35 U.S.C. §119(e) to, U.S. provisional patent application Ser. No. 60/862,838, filed Oct. 25, 2006, which provisional patent application is incorporated herein by reference.

### II. COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### III. BACKGROUND OF THE INVENTION

The present invention generally relates to dispensers, and more particularly, to liquid dispensers that are configured to be removably affixed to containers into which liquid held in the dispensers is, will be, or has been dispensed.

Dispensing containers for holding and then releasing various liquids and/or powders into separate containers are generally known. Some known dispensing containers take the form of a compartment integrated with a main container into which the material held in the dispensing container will be released. Exemplary patents disclosing compartmented containers include U.S. Pat. Nos. 3,039,644 and 3,305,368. In these compartmented containers, often the dispensing container is separated from the main container by a frangible sealing wall or sealing portion which is ruptured by a piercing element in order to release the material held in the dispensing container into the main container.

Known dispensing containers also take the form of a removable lid having a compartment formed therein for holding the material to be dispensed into a main container to which the lid fits in a covering relation. Exemplary patents disclosing lid-type dispensing containers include U.S. Pat. Nos. 3,779,372 and 7,017,735. The lid-type dispensing containers also generally have a frangible seal of some sort that is broken or ruptured upon manual manipulation in order to release the material held in the dispensing container into the main container.

Further, dispensing containers are known that take the form of an elongate tubular stirrer wherein the material to be dispensed is retained inside the stirrer. Exemplary patents disclosing stirrer-type dispensing containers include U.S. Pat. Nos. 4,387,809 and 4,816,268. The stirrer-type dispensing containers have various forms of seals for holding and then releasing the materials. For example, some stirrer-type dispensing containers have dissolvable seals, others have plugs, and still others have seals formed in walls of the containers that are broken by tearing away portions of the containers.

While known dispensing containers generally serve their intended purposes, it has been recognized that it would be desirable to have a dispensing container that is separate from, but that may be removably affixed to a drinking container in which the contents of the dispensing container are received.

### IV. SUMMARY OF THE INVENTION

The present invention includes many aspects and features.

Accordingly, a first aspect of the present invention relates to a liquid dispenser comprising a body defining an interior containment space for containing a liquid to be dispensed and a structure configured to mount the liquid dispenser onto a drinking container such that the liquid dispenser does not obstruct drinking from a rim of the drinking container.

In a feature of the first aspect, the structure is configured to mount the liquid dispenser onto a side of the rim of the drinking container such that the liquid dispenser covers only a small portion of the rim whereby the liquid dispenser does not obstruct drinking from the rim of the drinking container. In another feature of this aspect, the structure comprises an area of the body that is configured and dimensioned to receive a rim and portion of a sidewall of a container for mounting the liquid dispenser on a drinking container. With regard to this feature, the area comprises an opening formed in the body of the liquid dispenser. With further regard to this feature, the opening extends from a periphery of the liquid dispenser.

In an additional feature of this aspect, the structure comprises a resilient element providing tension for mounting the liquid dispenser onto the drinking container. In a further feature, the structure comprises an adhesive area located on the liquid dispenser for mounting the liquid dispenser onto the drinking container, whereby the liquid dispenser may be adhered to a surface of a sidewall of the drinking container. With regard to this feature, the adhesive area comprises a peel-off covering.

In another feature of this aspect, the structure comprises a clasp that is attached to the liquid dispenser and that is adapted to be attached to a rim or sidewall of the drinking container for mounting the liquid dispenser onto a drinking container. In yet another feature, the body of the liquid dispenser comprises a wall that defines the interior containment space and wherein the wall is at least semi-flexible such that the liquid dispenser may be squeezed in order to expel liquid contained within the interior containment space. In still another feature, the interior containment space holds up to twelve milliliters of liquid for dispensing. In other features, the liquid dispenser is disk-like in shape and has a generally triangular periphery.

In yet another feature, the liquid dispenser further comprises a liquid contained within the interior containment space. With regard to this feature, the liquid is a beverage additive. With further regard to this feature, the liquid is a flavoring and/or a nutritional supplement. In furtherance of this feature, the liquid comprises alcohol. It is preferred that the body of the liquid dispenser comprises indicia on a surface thereof that is indicative of the liquid retained therein.

In an additional feature, the liquid dispenser comprises a surface and color such that the liquid dispenser resembles an orange slice, a lemon slice, or a lime slice. In another feature, the interior containment space comprises separate, isolated chambers wherein a different liquid may be contained within each respective chamber. In still another feature, the liquid dispenser further comprises a sealing element which precludes a liquid contained within the interior containment space from flowing through a dispensing opening. With regard to this feature, the liquid dispenser further comprises a tear away member, wherein manipulation of the tear away member results in rupturing of the sealing element whereby the liquid may be dispensed. In furtherance of this feature, the tear away member is integrally formed with the sealing element, and the sealing element is integrally formed with a wall of the body of the liquid dispenser. In accordance with this feature, the tear away member comprises a tab that may be pulled and at least partially separated or torn from the body of the liquid dispenser. With further regard to this feature, the liquid dispenser has a generally triangular periphery, and the tear away member forms a corner of the liquid dispenser.

A second aspect of the present invention relates to a liquid dispenser comprising a body defining an interior containment space for containing a liquid to be dispensed and a structure configured to mount the liquid dispenser onto a drinking container. The structure comprises an elongate opening formed in the body of the liquid dispenser that generally divides the liquid dispenser into two portions, and approximately half of the volume of the interior containment space is located in the first portion of the body of the liquid dispenser.

In a feature of this aspect, the liquid dispenser further comprises a sealing element, which precludes a liquid contained within the interior containment space from flowing through a dispensing opening, and a tear away member. Manipulation of the tear away member results in rupturing of the sealing element whereby the liquid may be dispensed. With regard to this feature, the tear away member comprises a tab located on a peripheral edge of the body of the liquid dispenser proximate the elongate opening, and the tab protrudes from the body of the liquid dispenser.

A third aspect of the present invention relates to a liquid dispenser comprising a body defining an interior containment space for containing a liquid to be dispensed and a structure configured to mount the liquid dispenser onto a drinking container. The structure comprises an elongate opening formed in the body of the liquid dispenser that generally divides the liquid dispenser into two portions, and the volume of the interior containment space in the first portion is approximately equal to the volume of the interior containment space in the second portion.

A fourth aspect of the present invention relates to a liquid dispenser comprising a body defining an interior containment space for containing a liquid to be dispensed and a structure configured to mount the liquid dispenser onto a drinking container. The structure comprises an elongate opening formed in the body of the liquid dispenser that generally divides the liquid dispenser into two portions, and substantially all of the volume of the interior containment space is located in the first portion.

In a feature of this aspect, the liquid dispenser further comprises a sealing element, which precludes a liquid contained within the interior containment space from flowing through a dispensing opening, and a tear away member. Manipulation of the tear away member results in rupturing of the sealing element whereby the liquid may be dispensed. With regard to this feature, the sealing element is disposed between and integrally formed with the first portion and the second portion and/or the sealing element is formed from the same material as the body of the liquid dispenser. In furtherance of this feature, a portion of the body of the liquid dispenser bridges the slit between the first portion and the second portion. In accordance with this feature, the tear away member is located in a distal end of the second portion and is connected to the portion of the body of the liquid dispenser that bridges the slit between the first portion and the second portion. It is preferred that the first portion and the second portion are connected together for movement of the distal end of the second portion relative to the first portion such that, when the tear away member is torn from the portion of the body of the liquid dispenser that bridges the slit between the first portion and the second portion, the second portion nevertheless remains connected to the first portion.

A fifth aspect of the present invention relates to a liquid dispenser comprising a body defining an interior containment space for containing a liquid to be dispensed and a structure configured to mount the liquid dispenser onto a drinking container, wherein the structure comprises an elongate opening formed in the body of the liquid dispenser that generally divides the liquid dispenser into two portions, and wherein a substantial majority of the volume of the interior containment space is located in the first portion of the body of the liquid dispenser and a minority of the volume of the interior containment space is located in the second portion of the body of the liquid dispenser.

In a feature of this aspect, the liquid dispenser further comprises a sealing element, which precludes a liquid contained within the interior containment space from flowing through a dispensing opening, and a tear away member, wherein manipulation of the tear away member results in rupturing of the sealing element whereby the liquid may be dispensed, and wherein the sealing element and the tear away member are located in the second portion of the liquid dispenser. With regard to this feature, the sealing element is formed from the same material as the body of the liquid dispenser. In accordance with this feature, the sealing element comprises a thinner section of the body of the liquid dispenser. In furtherance of this feature, the tear away element comprises a nub of the second portion of the body of the liquid dispenser.

A sixth aspect of the present invention relates to a liquid dispenser comprising a body defining an interior containment space for containing a liquid to be dispensed and means for mounting of the body of the liquid dispenser onto a drinking container such that the liquid dispenser does not obstruct drinking from a rim of the drinking container. In a feature of this aspect, the structure is configured to mount the body of the liquid dispenser onto a side of the rim of the drinking container such that the liquid dispenser covers only a small portion of the rim whereby the liquid dispenser does not obstruct drinking from the rim of the drinking container.

A seventh aspect of the present invention relates to a combination of a drinking container and a liquid dispenser comprising a drinking container defining an interior containment space for a beverage for human consumption and a liquid dispenser comprising a body defining an interior containment space and a structure by which the body of the liquid dispenser is mounted onto the drinking container such that the liquid dispenser does not obstruct drinking from a rim of the drinking container.

In a feature of this aspect, the structure comprises an elongate slit formed in the body of the liquid dispenser within which is received a rim and a portion of a sidewall of the drinking container. With regard to this feature, the slit narrows at a point along its extent such that the narrowing of the slit provides a snap-fit attachment of the liquid dispenser onto the rim of the drinking container for secure mounting of the liquid dispenser onto the rim and sidewall of the drinking container.

In another feature, the structure is configured to mount the body of the liquid dispenser onto a side of the rim of the drinking container such that the liquid dispenser covers only a small portion of the rim whereby the liquid dispenser does not obstruct drinking from the rim of the drinking container. In yet another feature, the structure comprises an elastic element providing tension for the mounting of the body of the liquid dispenser onto the drinking container. In an additional feature, the structure comprises an adhesive area located on the body of the liquid dispenser for the mounting of the body of the liquid dispenser onto the drinking container, whereby the liquid dispenser may be adhered to a surface of a sidewall of the drinking container.

In a further feature, the structure comprises a clasp that is attached to the body of the liquid dispenser and that is adapted to be attached to a rim or sidewall of the drinking container for mounting of the body of the liquid dispenser onto a drinking container. In other features, the drinking container comprises a drinking glass and a disposable cup. In an additional feature, the combination further comprises one or more additional liquid dispensers mounted on the drinking container. In another feature, the liquid dispenser comprises a surface and color such that the liquid dispenser resembles an orange slice, a lemon slice, or a lime slice.

In an additional feature, a first portion of the liquid dispenser is located within the interior of the drinking container and a second portion of the liquid dispenser is located outside of the drinking container. With regard to this feature, approximately half of the interior containment space is located in the first portion. In furtherance of this feature, substantially all of the interior containment space is located in the first portion. In accordance with this feature, a substantial majority of the interior containment space is located in the first portion of the body of the liquid dispenser and a minority of the interior containment space is located in the second portion of the body of the liquid dispenser.

In a further feature, the body of the liquid dispenser comprises a wall that defines the interior containment space, and the wall is at least semi-flexible such that the liquid dispenser may be squeezed to expel any liquid within the interior containment space thereof In another feature, the interior containment space of the liquid dispenser holds up to twelve milliliters of liquid for dispensing. In yet another feature, the liquid dispenser is disk-like in shape. In other features, the drinking container comprises a glass and a cup.

An eighth aspect of the present invention relates to a combination of a drinking container and a liquid dispenser comprising a drinking container defining an interior containment space for a beverage for human consumption and a liquid dispenser comprising a body defining an interior containment space and means for mounting of the body of the liquid dispenser on a drinking container such that the liquid dispenser does not obstruct drinking from a rim of the drinking container.

A ninth aspect of the present invention relates to a combination of a drinking container and a liquid dispenser comprising a drinking container defining an interior containment space for a beverage for human consumption and a liquid dispenser mounted on a side of a rim of the drinking container such that the liquid dispenser does not obstruct drinking from the rim of the drinking container.

A tenth aspect of the present invention relates to a method of dispensing a liquid into a drinking container, the method comprising the steps of: (a) providing a liquid dispenser comprising, a body defining an interior containment space in which the liquid to be dispensed is contained and a structure for mounting of the body of the liquid dispenser onto the drinking container such that the liquid dispenser does not obstruct drinking from a rim of the drinking container; (b) dispensing the liquid from the liquid dispenser into the drinking container; and (c) mounting the liquid dispenser onto the drinking container via the structure of the liquid dispenser.

In a feature of this aspect, performance of said step (a) results in an unobstructed slit extending from a periphery of the liquid dispenser, within which unobstructed slit is received onto the rim of the drinking container during performance of said step (c). In another feature, the liquid dispenser comprises a structure for mounting of the liquid dispenser onto the rim of the drinking container only after the sealing element has been ruptured. In yet another feature, the liquid dispenser comprises means for mounting of the body of the liquid dispenser onto the drinking container. In still another feature, said step (c) is performed after step (b).

In an additional feature, said step (c) is performed before step (b). In another feature, said step (b) comprises squeezing the liquid dispenser such that liquid is expelled from the liquid dispenser into the drinking container. In a further feature, said step (c) comprises sliding the rim and a portion of a sidewall of the drinking container into an elongate slit of the liquid dispenser. In a still further feature, said step (a) comprises detaching a tear away member from the liquid dispenser. In yet another feature, said step (a) comprises partially detaching a tear away member from the liquid dispenser such that use of the liquid dispenser does not result in two pieces of waste for disposal but, instead, only in a single piece of waste for disposal.

In another feature, said step (c) comprises mounting the liquid dispenser in an orientation in which a dispensing opening of the liquid dispenser is located within an interior of the drinking container. With regard to this feature, said step (b) is performed after said step (c). With further regard to this feature, said step (b) comprises squeezing the liquid dispenser such that liquid is expelled from the liquid dispenser into the drinking container.

An eleventh aspect of the present invention relates to a method of dispensing a liquid into a drinking container, the method comprising the steps of: (a) rupturing a sealing element of a liquid dispenser so as to expose a dispensing opening through which liquid contained in the liquid dispenser may be dispensed; (b) dispensing the liquid from the liquid dispenser into the drinking container; and (c) mounting the liquid dispenser onto a rim of the drinking container such that the liquid dispenser does not obstruct drinking from the rim of the drinking container.

In a feature of this aspect, said step (c) is performed after step (b). In another feature, said step (c) is performed before step (b). In still another feature, said step (b) comprises squeezing the liquid dispenser such that liquid is expelled from the liquid dispenser into the drinking container. In yet another feature, said step (c) comprises sliding the rim and a portion of a sidewall of the drinking container into an elongate slit of the liquid dispenser.

In an additional feature, said step (a) comprises detaching a tear away member from the liquid dispenser. In a further feature, said step (a) comprises partially detaching a tear away member from the liquid dispenser such that use of the liquid dispenser does not result in two pieces of waste for disposal but, instead, only in a single piece of waste for disposal. In a still further feature, said step (c) comprises mounting the liquid dispenser in an orientation in which a dispensing opening of the liquid dispenser is located within an interior of the drinking container. With regard to this feature, said step (b) is performed after said step (c). With further regard to this feature, said step (b) comprises squeezing the liquid dispenser such that liquid is expelled from the liquid dispenser into the drinking container.

In another feature, said step (c) comprises mounting the liquid dispenser in an orientation in which a first portion of the liquid dispenser is located within an interior of the drinking container and a second portion of the liquid dispenser is located exterior to the drinking container. In accordance with this feature, a dispensing opening of the liquid container faces downwardly into the drinking container when the liquid dispenser is mounted in the orientation, said dispensing opening being below the rim of the drinking container. In furtherance of this feature, a dispensing opening of the liquid container faces a sidewall of the drinking container when the liquid dispenser is mounted in the orientation, said dispensing opening being below the rim of the drinking container.

In an additional feature, the method further comprises the steps of (a) rupturing a sealing element of a second liquid dispenser so as to expose a dispensing opening through which liquid contained in the liquid dispenser may be dispensed; (b) dispensing the liquid from the second liquid dispenser into the drinking container; and (c) mounting the second liquid dispenser onto the rim of the drinking container such that neither the first liquid dispenser nor the second liquid dispenser obstructs drinking from the rim of the drinking container. In other features, the drinking container comprises a glass and a disposable cup. In another feature, the liquid is a beverage additive. In further features, the liquid is a flavoring, is a nutritional supplement, and comprises alcohol.

A twelfth aspect of the present invention relates to a method of dispensing a liquid into a drinking container, the method comprising the steps of: (a) rupturing a sealing element of a liquid dispenser so as to expose a dispensing opening through which liquid contained in the liquid dispenser may be dispensed; (b) squeezing the liquid dispenser such that liquid is expelled from the liquid dispenser into the drinking container; and (c) positioning a rim and a portion of a sidewall of the drinking container into an elongate slit of the liquid dispenser such that the liquid dispenser is mounted onto the drinking container in a snap-fit attachment. In a feature of this aspect, said step (c) is performed after step (b). In another feature, said step (c) is performed before step (b).

In addition to the aforementioned aspects and features of the present invention, it should be noted that the present invention further encompasses the various possible combinations of such aspects and features.

### V. BRIEF DESCRIPTION OF THE DRAWINGS

One or more preferred embodiments of the present invention now will be described in detail with reference to the accompanying drawings, wherein the same elements are referred to with the same reference numerals, and wherein:

FIG. 1 is a perspective view of a liquid dispenser in accordance with a first embodiment of the present invention.

FIG. 2 is a front elevational view of the liquid dispenser of FIG. 1.

FIG. 3 is a side elevational view of the liquid dispenser of FIG. 1.

FIG. 4 is another perspective view of the liquid dispenser of FIG. 1 wherein a tab is detached from the liquid dispenser.

FIG. 5 is a perspective view of a drinking container having a plurality of liquid dispensers of FIG. 1 affixed thereto.

FIG. 6 is a perspective view of a liquid dispenser in accordance with a second embodiment of the present invention.

FIG. 7 is a perspective view of a liquid dispenser in accordance with a third embodiment of the present invention.

FIG. 8 is a perspective view of a liquid dispenser in accordance with a variation of the first embodiment of the present invention.

### VI. DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein-as understood by the Ordinary Artisan based on the contextual use of such term-differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

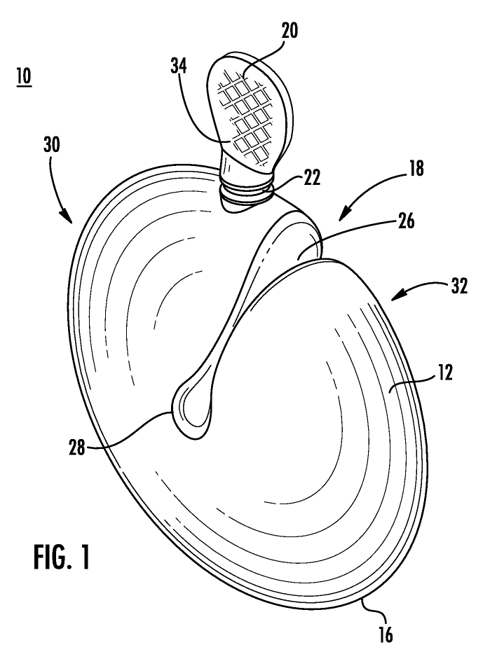

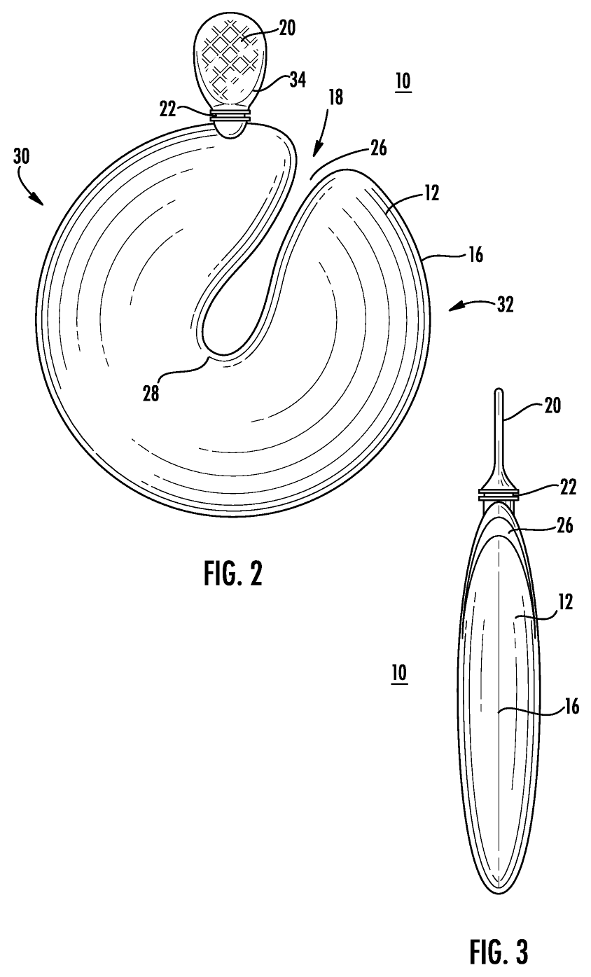

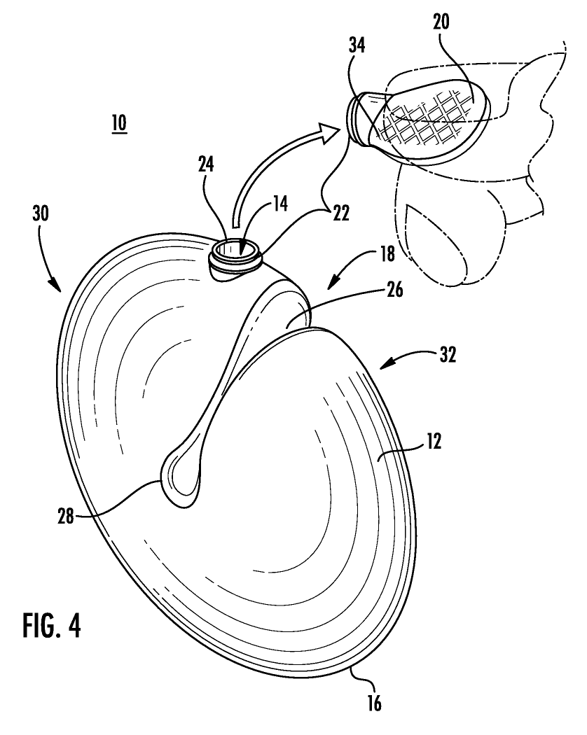

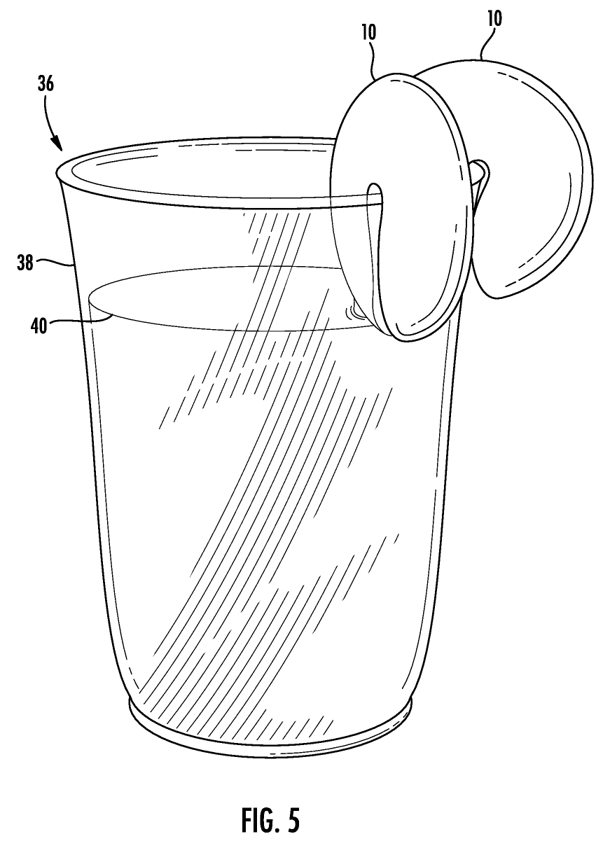

Turning now to FIGS. 1-3, these figures illustrate a first embodiment of the present invention. More particularly, FIG. 1 is a perspective view of a liquid dispenser in accordance with a preferred first embodiment of the present invention. FIG. 2 is a front elevational view of the liquid dispenser of FIG. 1, and FIG. 3 is a side elevational view of the liquid dispenser of FIG. 1. FIG. 4 is another perspective view of the liquid dispenser of FIG. 1 wherein a tab is detached from the liquid dispenser, and FIG. 5 is a perspective view of a drinking container having a plurality of liquid dispensers of FIG. 1 mounted thereon.

The liquid dispenser 10 is generally hollow and includes a wall 12 defining an interior space wherein liquid is held. The liquid dispenser 10 also is generally disk-like in shape, in that the liquid dispenser 10 has a generally round cross-section and a generally narrow thickness. In addition, the thickness of the liquid dispenser 10 tapers near a peripheral edge 16 thereof. Preferably, the wall 12 is at least semi-flexible such that the liquid dispenser 10 may be squeezed to expel liquid contained within the interior space.

To dispense liquids from the dispenser 10 of FIG. 1, a tear away member 20 is at least partially-and preferably completely-detached from the liquid dispenser 10. Detachment of the tear away member 20, which may comprise a tab, ruptures a sealing element 22 and exposes a dispensing opening or mouth 14, defined by a portion 24 of the sealing element 22, into the interior space in which the liquid is held. Until such detachment, the sealing element 22 prevents liquid from flowing through the dispensing opening 14. The dispensing opening 14 is illustrated FIG. 4, wherein the tab 20 has been completely removed from the liquid dispenser 10. The tab 20 projects outwardly away from the edge 16 of the dispenser 10 to facilitate manual grasping by the fingers. Preferably, a base 34 of the tab 20 is integrally formed with the sealing element 22 for seamless transition therebetween. Moreover, the sealing element 22 preferably is integrally formed with the wall 12 of the liquid dispenser from the same material and comprises a thinner section of the material relative to the wall 12. The sealing element 22 extends between and connects the wall 12 of the dispenser 10 and the tab 20 and is relatively easily ruptured for detachment of the tab 20 from the wall 12.

The liquid dispenser 10 further includes an area 18 that is dimensioned and configured to releasably mount the dispenser 10 to a drinking container, such as a glass or cup. More particularly, the liquid dispenser 10 includes an area 18 that is dimensioned and configured to releasably affix the dispenser 10 onto a rim of a drinking container. An example of the attachment of two liquid dispensers 10 to the rim and sidewall 38 of a drinking container 36 is illustrated in FIG. 5.

The area 18 of the liquid dispenser 10 comprises a recessed area, and more particularly, an elongate slit 26 that is formed by the wall 12 of the liquid dispenser 10. The slit 26 is dimensioned and configured to receive and grasp therein a rim and a portion of a sidewall of a drinking container. The slit 26 also extends generally inwardly from the edge 16 of the dispenser 10 toward a central area 28 of the dispenser 10. The slit 26 thereby generally partially bisects the dispenser 10, dividing it into two portions 30,32. The slit 26 also preferably narrows at a point along its extent. The narrowing of the slit 26 further enables a grasping function for securely mounting the liquid dispenser 10 onto the rim and sidewall of a drinking container.

FIG. 5 is a perspective view of a drinking container 36 such as a glass or cup that has a plurality of liquid dispensers 10 mounted thereon. Two dispensers 10 are shown affixed to the drinking container 36. Alternatively, a single liquid dispenser 10 may be affixed to the drinking container 36 or more than two liquid dispensers 10 may be affixed to a drinking container 36, as desired.

FIG. 5 serves to illustrate the drinking container 36 in an exemplary scenario in which liquid dispensers 10 may be used. In particular, the drinking container 36 and the liquid dispensers 10 may be served as shown in FIG. 5 to a patron in a commercial eating establishment, i.e., a person may order a beverage having two drink additives accompanying it, and a server may bring the order to the person as is shown in FIG. 5. In this exemplary scenario, the tabs 20 of the liquid dispensers 10 may not yet been be detached for dispensing liquids from the dispensers 10 into the drinking container 36.

When a liquid dispenser 10 is affixed to a drinking container, the rim and wall 38 of the drinking container 36 is received within the slit 26 of the liquid dispenser 10 and the liquid dispenser 10 is oriented in a dispensing position wherein the dispensing opening or mouth 14 is disposed within the interior of the drinking container 36. Furthermore, a first portion 30 is located within the interior of the drinking container and a second portion 32 is located exterior to the drinking container. When the tab 20 has been removed and the liquid dispenser 10 is mounted in the dispensing position, the mouth 14 of the liquid dispenser 10 will be open to the interior of the drinking container 36.

Continuing to refer to FIG. 5, it is contemplated that a beverage 40 will be contained in the drinking container 36 and that the liquid held in a liquid dispenser 10 will be mixed with the beverage 40 in the drinking container 36. Furthermore, while gravity acts to encourage liquid to flow freely from the dispenser 10 into the beverage 40, it is preferred that a user will squeeze the liquid dispenser 10 in order to expel liquid into the drinking container 36. Squeezing the liquid from the liquid dispenser 10 will increase the velocity of the liquid as it exits the mouth 14 which, in turn, will aid in the mixing of the expelled liquid with the beverage 40.

It also is contemplated that an overlay, having a relatively smaller opening disposed therein, may be applied to the dispensing opening 14 such that the liquid would be expelled there through. The smaller opening of such an overlay serves to further increase the velocity of the liquid as it exits the liquid dispenser 10 which, in turn, further aids in the mixing of the liquid with the beverage 40.

After liquid has been dispensed from a liquid dispenser 10, the liquid dispenser 10 may be returned or left on the drinking container 36 while the beverage having the added liquid is consumed. The dispenser 10 is sufficiently narrow so as not to impede consumption. In alternative variations, the liquid dispenser 10 includes surface contours and colors so as to resemble a lemon, lime, or orange slice and thereby serves to decoratively embellish the drinking container 36. In other variations, the liquid dispenser 10 includes indicia on surfaces thereof that are indicative of the liquid retained therein. Such indicia may include trademarks or brand indications for the liquids. Alternatively, if desired, a liquid dispenser 10 may be removed from the drinking container 36 after the liquid is dispensed. It is contemplated that the dispensers 10 may be single-use disposable items and may be thrown away after use.

Any kinds of liquids that may be desirable to add to beverages may be contained in liquid dispensers 10. Liquid dispensers 10 may contain beverage additives such as flavoring liquids. Examples may include, but are not limited to, flavors such as lemon, lime, raspberry, strawberry, vanilla, hazelnut, and the like. The liquid dispensers 10 may also contain various nutritional supplement liquids. Examples may include, but are not limited to, protein supplements, energy boost supplements, various vitamin supplements, and the like. The liquid dispensers 10 may also include various alcoholic beverages. Examples include, but are not limited to, vodka, rum, bourbon, whiskey, and the like.

It is contemplated that a liquid dispenser 10 will be capable of holding up to twelve milliliters (12 ml) of liquid. The actual volume in any particular instance may be varied as desired by changing the size or configuration of the liquid dispenser 10.

It further is contemplated that liquid dispensers 10 will be constructed of plastic, which in at least some embodiments is a flexible plastic such that the dispensers 10 may be readily compressed between the user's fingers. Examples of suitable plastics include, but are not limited to, low density polyethylene (LDPE), low density polypropylene (LDPP), medium density polyethylene (MDPE), and medium density polypropylene (MDPP).

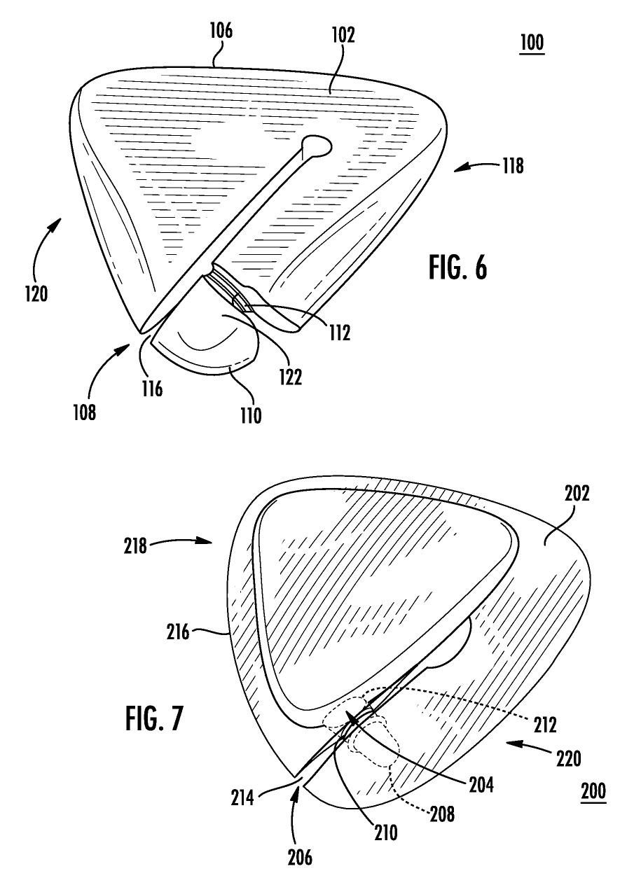

FIG. 6 is a perspective view of a liquid dispenser 100 in accordance with a preferred second embodiment of the present invention. Similar to the liquid dispenser 10 of FIG. 1, the liquid dispenser 100 is generally hollow and includes a wall 102 defining an interior space wherein liquid is retained. The liquid dispenser 100 has a generally triangular perimeter and a relatively narrow thickness. The thickness of the dispenser 100 tapers near the peripheral edges 106 of the dispenser 100. Preferably, the wall 102 is at least semi-flexible such that the liquid dispenser 100 may be squeezed in order to expel liquid contained within the interior space.

The liquid dispenser 100 includes a tear away member 110 that, when manually manipulated or pulled, ruptures a sealing element 112 to expose a dispensing opening through which liquid may be dispensed. As illustrated, the tear away member 110 may comprise a tab 110 that may be pulled and at least partially separated or torn from the liquid dispenser 100. The tab 110 comprises a corner of the generally triangular perimeter of the liquid dispenser 100. A base 122 of the tab 110 preferably is integrally formed with the sealing element 112 for seamless transition therebetween. Moreover, the sealing element 112 preferably is integrally formed with the wall 102 of the liquid dispenser 100 from the same material and comprises a thinner section of the material relative to the wall 102. The sealing element 112 extends between and connects the wall 102 of the liquid dispenser 100 and the tab 110 and is relatively easily ruptured for detachment of the tab 110 from the wall 102. The sealing element 112 prevents liquid from flowing through a dispensing opening through which liquid is dispensed when the tab 112 is detached.

The liquid dispenser 100 further includes an area 108 that is dimensioned and configured to releasably mount the liquid dispenser 100 to a drinking container into which the liquid is to be dispensed. The area 108 comprises an elongate slit 116 formed in the liquid dispenser 100. The slit 116 projects generally inwardly from one of the edges 106 of the liquid dispenser 100. The slit 116 partially divides the volume of the dispenser 100 into two unequal portions 118,120.

To mount the liquid dispenser 100 to a drinking container, the liquid dispenser 100 is slid onto the rim of the drinking container, with the rim and a portion of the sidewall of the drinking container being received within the slit 116 of the liquid dispenser 100. The length of the slit 116 is such that it enables the dispenser 100 to be securely mounted on the wall of the drinking container. The dispenser 100 thereby sits on the wall of the drinking container with portion 118 located within the interior of the drinking container and portion 120 located exterior to the drinking container.

To dispense liquid from the dispenser 100, the tab 110 is detached, thereby rupturing the sealing element 112 and exposing the dispensing opening through which the liquid may then be dispensed. Furthermore, while gravity acts to encourage liquid to flow freely from the dispenser 100, it is preferred that a user squeeze the liquid dispenser 100 to expel the liquid from the liquid dispenser 100. Expelling liquid from the liquid dispenser 100 will increase the velocity of the liquid as it exits the dispenser 100 and thereby aid in the mixing of the liquid with a beverage.

After liquid has been dispensed from a the liquid dispenser 100, the liquid dispenser 100 may be returned to or left on the drinking container during consumption. The liquid dispenser 100 is sufficiently narrow so as not to impede drinking. However, the liquid dispenser 100 may be removed from the drinking container after the liquid has been dispensed and disposed of, as desired. It is contemplated that the liquid dispenser 100 is a single-use disposable item and may be thrown away after use.

In alternative variations, the liquid dispenser 100 includes indicia on surfaces thereof that are indicative of the liquids retained therein. Such indicia may include trademarks or brand indications for the liquids.

Any kinds of liquids that may be desirable to add to beverages may be contained in liquid dispensers 100. Liquid dispensers 100 may contain beverage additives such as flavoring liquids. Examples may include, but are not limited to, flavors such as lemon, lime, raspberry, strawberry, vanilla, hazelnut, and the like. The liquid dispensers 100 may also contain various nutritional supplement liquids. Examples may include, but are not limited to, protein supplements, energy boost supplements, various vitamin supplements, and the like. The liquid dispensers 100 may also include various alcoholic beverages. Examples include, but are not limited to, vodka, rum, bourbon, whiskey, and the like.

It is contemplated that a liquid dispenser 100 will be capable of holding up to twelve milliliters (12 ml) of liquid. The actual volume in any particular instance may be varied as desired by changing the size or configuration of the liquid dispenser 100.

It further is contemplated that liquid dispensers 100 will be constructed of plastic, which in at least some embodiments is a flexible plastic such that the dispensers 10 may be readily compressed between the user's fingers. Examples of suitable plastics include, but are not limited to, low density polyethylene (LDPE), low density polypropylene (LDPP), medium density polyethylene (MDPE), and medium density polypropylene (MDPP).

FIG. 7 is a perspective view of a liquid dispenser 200 in accordance with a preferred third embodiment of the present invention. Similar to the liquid dispensers 10,100 of FIG. 1 and FIG. 6, respectively, the liquid dispenser 200 is generally hollow and includes a wall 202 defining an interior space wherein liquid is retained. The liquid dispenser 200 has a generally triangular perimeter and a relatively narrow thickness. Preferably, the wall 202 is at least semi-flexible such that the liquid dispenser 200 may be squeezed in order to expel liquid contained within the interior space.

The liquid dispenser 200 includes an area 206 that is dimensioned and configured to releasably mount the liquid dispenser 200 to a drinking container into which the liquid is to be dispensed. The area 206 comprises an elongate slit 214 formed in the liquid dispenser 200. The slit 214 projects generally inwardly from one of the edges 216 of the liquid dispenser 200. The slit 214 partially divides the volume of the dispenser 100 into two unequal portions 218,220. Additionally, unlike the previously described embodiments 10,100, in the liquid dispenser 200 of FIG. 7, the interior space and, therefore, the volume of liquid contained therein, is primarily located in one rather than two portions of the dispenser 200. More particularly, the interior space is primarily located in a first portion 218 of the dispenser 200, although a small amount may be contained within a recess 208 formed in a second portion 220.

The liquid dispenser 200 includes a sealing element 210 that is disposed between and integrally formed with the portions 218,220. The sealing element 210 further is formed from the same material as the wall 202 of the dispenser 200 but is thinner than the wall thickness 202 of the portions 218,220. The sealing element 210 prevents liquid from flowing through a dispensing opening 204, defined by a portion 212 of the sealing element 210, in the wall 202 of the dispenser 200; however, the sealing element 210 is relatively easily ruptured or separated when liquid is desired to be dispensed by manipulation of portions 220,218 and, specifically, by grasping ends of the portions 218,220 and tearing the sealing element 210.

As will be appreciated, the liquid should be dispensed from the liquid dispenser 200 prior to mounting of the liquid dispenser to a drinking container. Moreover, the second portion 220 is not intended to be completely separated from the first portion 218 when the sealing element 210 is ruptured. Thus, to mount the liquid dispenser 200 to the drinking container, the sealing element 210 is first torn (thereby opening the slit 214 to reception therein of the rim and sidewall of the drinking container) and then the liquid dispenser 200 is slid onto a rim and sidewall of a drinking container, with the rim and sidewall of the drinking container being received within the slit 214. Furthermore, the length of the slit 214 is such that it enables the liquid dispenser 200 to be securely affixed to the sidewall of the drinking container. The liquid dispenser 200 sits on the wall of the drinking container, with the first portion 218 located interior to the wall of the drinking container and the second portion 220 located exterior to the wall of the drinking container. In addition, the dispensing opening 212 is located relatively below a top of the drinking container.

It further will be appreciated that using the dispenser 200 does not result in two pieces of waste for disposal but, instead, only in a single piece of waste since it is intended that the first portion 218 remain attached to the second portion 220 for mounting of the liquid dispenser 200 to the drinking container. Complete detachment of the first portion 218 from the second portion 220 would destroy the slit 214 and thereby preclude the capability of mounting of the liquid dispenser 200 to a drinking container in accordance with preferred embodiments of the present invention. It is noted that dispenser 200 may be preferred by commercial establishments who seek to offer additive liquids to customers in preferred liquid dispensers of the present invention because the number of items of waste produced by their customers will be reduced.

In alternative variations, the liquid dispenser 200 includes indicia on surfaces thereof that are indicative of the liquids retained therein. Such indicia may include trademarks or brand indications for the liquids.

Any kinds of liquids that may be desirable to add to beverages may be contained in liquid dispensers 200. Liquid dispensers 200 may contain beverage additives such as flavoring liquids. Examples may include, but are not limited to, flavors such as lemon, lime, raspberry, strawberry, vanilla, hazelnut, and the like. The liquid dispensers 200 may also contain various nutritional supplement liquids. Examples may include, but are not limited to, protein supplements, energy boost supplements, various vitamin supplements, and the like. The liquid dispensers 200 may also include various alcoholic beverages. Examples include, but are not limited to, vodka, rum, bourbon, whiskey, and the like.

It is contemplated that a liquid dispenser 200 will be capable of holding up to twelve milliliters (12 ml) of liquid. The actual volume in any particular instance may be varied as desired by changing the size or configuration of the liquid dispenser 200. It further is contemplated that liquid dispensers 200 will be constructed of plastic, which in at least some embodiments is a flexible plastic such that the dispensers 200 may be readily compressed between the user's fingers. Examples of suitable plastics include, but are not limited to, low density polyethylene (LDPE), low density polypropylene (LDPP), medium density polyethylene (MDPE), and medium density polypropylene (MDPP).

The preferred liquid dispensers 10,100,200 of the present invention each provides a dispensing container that is separate from a drinking container into which the contents of the liquid dispenser 10,100,200 will be released, but that may be removably affixed to the drinking container. Each liquid dispenser 10,100,200 may be used to dispense all or some portion of its contents into the drinking container and then may be conveniently kept on the drinking container as a decorative embellishment while a beverage therein is consumed.

In addition to the foregoing, it is contemplated that a liquid dispenser may be mounted or otherwise directly attached to a sidewall or other portion of a drinking container by other than the above-described slit arrangement, and that a liquid dispenser may include other types of structures for such mounting. For example, a liquid dispenser may include an adhesive area located on the dispenser such as, for instance, a peel-off adhesive backing attached to a wall of the liquid dispenser, whereby the dispenser may be adhered to a surface a sidewall of the drinking container. Moreover, such attachment may be permanent or temporary. Other structural arrangements that may be used to attach the dispenser to the drinking container may include a clasp or binder that is attached to the liquid dispenser and that is adapted to be attached to a rim or sidewall of the drinking container.

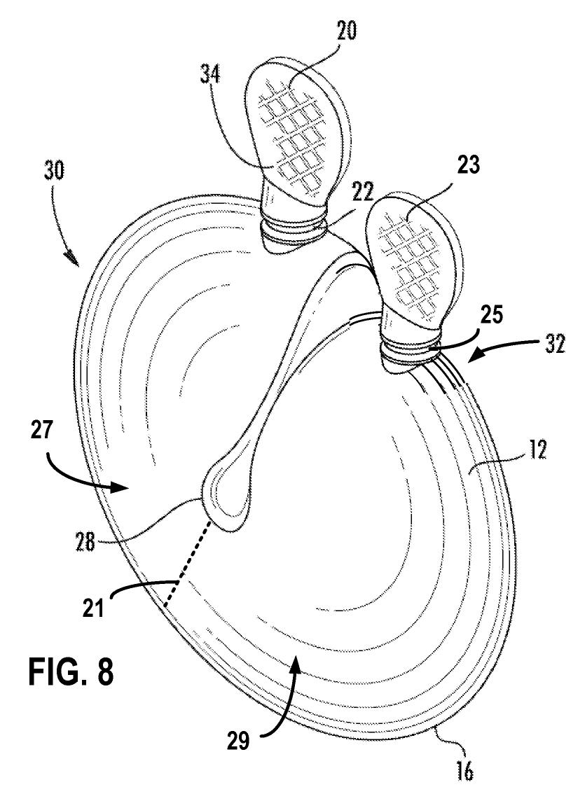

Additionally, it is contemplated that an interior space of a liquid dispenser may be divided into separate chambers with each chamber containing a different liquid. For example, with regard to FIG. 8, a liquid dispenser may include an interior containment space divided into two separate, isolated chambers 27,29 by a dividing wall 21, wherein one chamber 27 contains, for instance, lemon flavoring and the other chamber 29 contains, for instance, vodka for use by a person wishing to consume a mixed alcoholic beverage. In further regard to this, the liquid dispenser may include separate sealing elements 22,23 and tabs 20,25, respectively, for the separate chambers 27,29. The lemon flavoring and the vodka then may be dispensed into a beverage individually, as desired.

Finally, it is contemplated that a liquid dispenser in accordance with some embodiments of the present invention may include aspects and features as disclosed herein, but may not include any structural features for mounting of the liquid dispenser to a drinking container. For instance, it is contemplated that a liquid dispenser in accordance with some embodiments of the present invention may include aspects and features disclosed herein without regard to whether any structural features thereof are actually used for mounting of the liquid dispenser to a drinking container.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A liquid dispenser, comprising a body defining an interior containment space for containing a liquid to be dispensed and a structure configured to mount the liquid dispenser onto a drinking container such that the liquid dispenser does not obstruct drinking from a rim of the drinking container.

2. The liquid dispenser of claim 1, wherein the structure is configured to mount the liquid dispenser onto a side of the rim of the drinking container such that the liquid dispenser covers only a small portion of the rim whereby the liquid dispenser does not obstruct drinking from the rim of the drinking container.

3. The liquid dispenser of claim 1, wherein the structure comprises an area of the body that is configured and dimensioned to receive a rim and portion of a sidewall of a container for mounting the liquid dispenser on a drinking container.

4. The liquid dispenser of claim 3, wherein the area comprises an opening formed in the body of the liquid dispenser.

5. The liquid dispenser of claim 4, wherein the opening extends from a periphery of the liquid dispenser.

6. The liquid dispenser of claim 1, wherein the structure comprises a resilient element providing tension for mounting the liquid dispenser onto the drinking container.

7. The liquid dispenser of claim 1, wherein the structure comprises an adhesive area located on the liquid dispenser for mounting the liquid dispenser onto the drinking container, whereby the liquid dispenser may be adhered to a surface of a sidewall of the drinking container.

8. The liquid dispenser of claim 7, wherein the adhesive area comprises a peel-off covering.

9. The liquid dispenser of claim 1, wherein the structure comprises a clasp that is attached to the liquid dispenser and that is adapted to be attached to a rim or sidewall of the drinking container for mounting the liquid dispenser onto a drinking container.

10. The liquid dispenser of claim 1, wherein the body of the liquid dispenser comprises a wall that defines the interior containment space and wherein the wall is at least semi-flexible such that the liquid dispenser may be squeezed in order to expel liquid contained within the interior containment space.

11. The liquid dispenser of claim 1, wherein the interior containment space holds up to twelve milliliters of liquid for dispensing.

12. The liquid dispenser of claim 1, wherein the liquid dispenser is disk-like in shape.

13. The liquid dispenser of claim 1, wherein the liquid dispenser has a generally triangular periphery.

14. The liquid dispenser of claim 1, further comprising a liquid contained within the interior containment space.

15. The liquid dispenser of claim 14, wherein the liquid is a beverage additive.

16. The liquid dispenser of claim 14, wherein the liquid is a flavoring.

17. The liquid dispenser of claim 14, wherein the liquid is a nutritional supplement.

18. The liquid dispenser of claim 14, wherein the liquid comprises alcohol.

19. The liquid dispenser of claim 14, wherein the body of the liquid dispenser comprises indicia on a surface thereof that is indicative of the liquid retained therein.

20. The liquid dispenser of claim 1, wherein the liquid dispenser comprises a surface and color such that the liquid dispenser resembles an orange slice, a lemon slice, or a lime slice.

21. The liquid dispenser of claim 1, wherein the interior containment space comprises separate, isolated chambers and wherein a different liquid is contained within each chamber.

22. The liquid dispenser of claim 1, further comprising a sealing element which precludes a liquid contained within the interior containment space from flowing through a dispensing opening.

23. The liquid dispenser of claim 22, further comprising a tear away member, wherein manipulation of the tear away member results in rupturing of the sealing element whereby the liquid may be dispensed.

24. The liquid dispenser of claim 23, wherein the tear away member is integrally formed with the sealing element, and wherein the sealing element is integrally formed with a wall of the body of the liquid dispenser.

25. The liquid dispenser of claim 23, wherein the tear away member comprises a tab that may be pulled and at least partially separated or torn from the body of the liquid dispenser.

26. The liquid dispenser of claim 23, wherein the liquid dispenser has a generally triangular periphery, and wherein the tear away member forms a corner of the liquid dispenser.
